(19) United States
(12) Patent Application Publication
(10) Pub. No.: US 2005/0024807 A1
(43) Pub. Date: Feb. 3, 2005

(54) Electric discharge weapon system

(76) Inventors: Milan Cerovic, Scottsdale, AZ (US); Magne H. Nerheim, Scottsdale, AZ (US)

Correspondence Address: SQUIRE, SANDERS & DEMPSEY L.L.P, 600 HANSEN WAY, PALO ALTO, CA, 94304-1043, US

(21) Appl. No.: 10/855,924

(22) Filed: May 27, 2004

Related U.S. Application Data
(63) Continuation-in-part of application No. 10/447,447, filed on May 29, 2003.
Application No. 10/447,447 is a continuation-in-part of application No. 10/364,164, filed on Feb. 11, 2003.

(51) Int. Cl. H02H 1/00

(52) U.S. Cl. 361/232

(57) ABSTRACT

Embodiments of an electric discharge weapon system and methods of use are disclosed. In accordance with one embodiment, the weapon system may include a weapon that includes a body portion adapted for discharging a force (such as, for example, an electric discharge or an electric discharge projectile) towards a target, a handgrip coupled to the body portion, a trigger adapted for initiating the discharge of the force, and a display coupled to the body portion.

### CROSS-REFERENCE TO RELATED APPLICATIONS

This application is a continuation-in-part of U.S. patent application Ser. No. 10/447,447, filed May 29, 2003 by Max Nerheim, which is a continuation-in-part of U.S. patent application Ser. No. 10/364,164, filed Feb. 11, 2003 by Max Nerheim, both commonly owned, currently pending, and incorporated herein by this reference.

### TECHNICAL FIELD

Embodiments of the present invention relate to weapon systems, and more particularly to electric discharge weapon systems.

### BACKGROUND

Non-lethal force weapons may be utilized to deliver a non-lethal force at a target so that the target is incapacitated in a manner that is less likely to cause serious or permanent injury to the target than traditional firearms such as rifles, shotguns, and handguns. Electric discharge weapons may be utilized as a non-lethal force weapon. Electric discharge weapons generate a high energy electrical signal so that an electric shock may be applied to a target and thereby immobilize or stun the target.

### SUMMARY

Embodiments of an electric discharge weapon system and methods of use are disclosed. In accordance with one embodiment, the weapon system may include a weapon that includes a body portion adapted for discharging a force (such as, for example, an electric discharge or an electric discharge projectile) towards a target, a handgrip coupled to the body portion, a trigger adapted for initiating the discharge of the force, and a display coupled to the body portion.

The body portion may have a longitudinal aiming groove in an top face of the body portion. Also, a sight may be coupled to the top face of the body portion, the sight and the aiming groove lying along a common axis. A fin may be coupled to the sight. In such an embodiment, the fin may have an apex the is orientated so that is lies along the common axis. Further, the weapon may also include a colored region on the body portion that extends into a back end area of the aiming groove. As an option, the colored region and the fin may be colored in a common color such as, for example, a phosphorescent color.

The handgrip may include a cavity that receives a power supply and may also include a locking mechanism capable of releasably holds the power supply in the cavity. The display may be positioned beneath a back end of the aiming groove. In one embodiment, the display may be orientated at an obtuse angle to a longitudinal axis of the body portion.

In one embodiment, a plate may be coupled to the body portion that displays thereon indicia comprising an identifier associated with the weapon. In another embodiment, a safety switch may be coupled to the body portion. The safety switch may be movable between a locked position and an unlocked position. In a further embodiment, a light source may be coupled to the body portion. In such an embodiment, a switch for controlling activation of the light source may also be provided on the weapon.

The weapon system may also include a holster into which the weapon may be inserted. The holster may include a back portion that covers the display when the weapon is inserted into the holster.

In one embodiment, back portion of the holster may be resiliently deflectable and has a thumb grip extending therefrom for assisting deflection of the back portion by a user. In another embodiment, the holster may have a generally V-shaped edge with a notch therein. The notch is adapted for urging the safety switch from the unlocked position to the locked position as the weapon is inserted into the holster, the V-shaped edge of the holster holding the safety switch in the locked position when the weapon is in the holster. In a further embodiment the holster may have a hole which is positioned so that the plate is visible through the hole when the weapon is in the holster.

### BRIEF DESCRIPTION OF THE DRAWINGS

Embodiments are described with reference to the drawing, wherein like designations denote like elements, and:

FIG. 1 is a schematic perspective view of an exemplary electric discharge weapon without a discharge cartridge;

FIG. 2 is a schematic side view of an exemplary electric discharge weapon without a discharge cartridge;

FIG. 3 is a schematic top view of an exemplary electric discharge weapon without a discharge cartridge;

FIG. 4 is a schematic perspective view of an exemplary electric discharge weapon with a discharge cartridge;

FIG. 5 is a schematic side view of an exemplary holster for receiving an electric discharge weapon;

FIG. 6 is a schematic perspective view of an exemplary holster for receiving an electric discharge weapon;

FIG. 7 is another schematic perspective view of an exemplary holster for receiving an electric discharge weapon;

FIG. 8 is a schematic perspective view of an exemplary electric discharge weapon inserted into an exemplary holster;

FIG. 9 is another schematic perspective view of an exemplary electric discharge weapon inserted into an exemplary holster;

FIG. 10 is a schematic side view of an exemplary electric discharge weapon inserted into an exemplary holster;

FIG. 11 is a schematic perspective view of an exemplary electric discharge weapon without a discharge cartridge and with a battery power supply partially extending from a handgrip of the weapon;

FIG. 12 is schematic perspective view of an exemplary electric discharge weapon illustrating the discharge of probes from a discharge cartridge; and

FIG. 13 is a schematic block diagram of an exemplary electric discharge weapon.

### DETAILED DESCRIPTION

In general, the weapon system includes a weapon for discharging a force (preferably a non-lethal force), such as, for example, an electric discharge. The weapon generally includes a body portion, a handgrip coupled to the body portion, a trigger adapted for initiating the discharge of the force, and a display coupled to the body portion. The weapon system may also include a holster into which the weapon may be inserted.

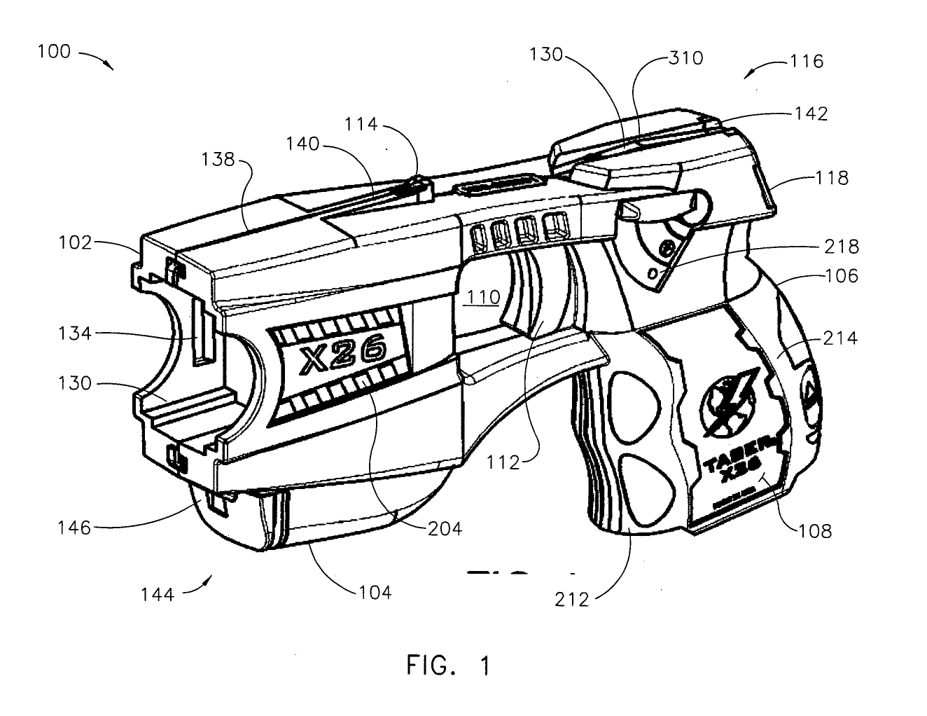

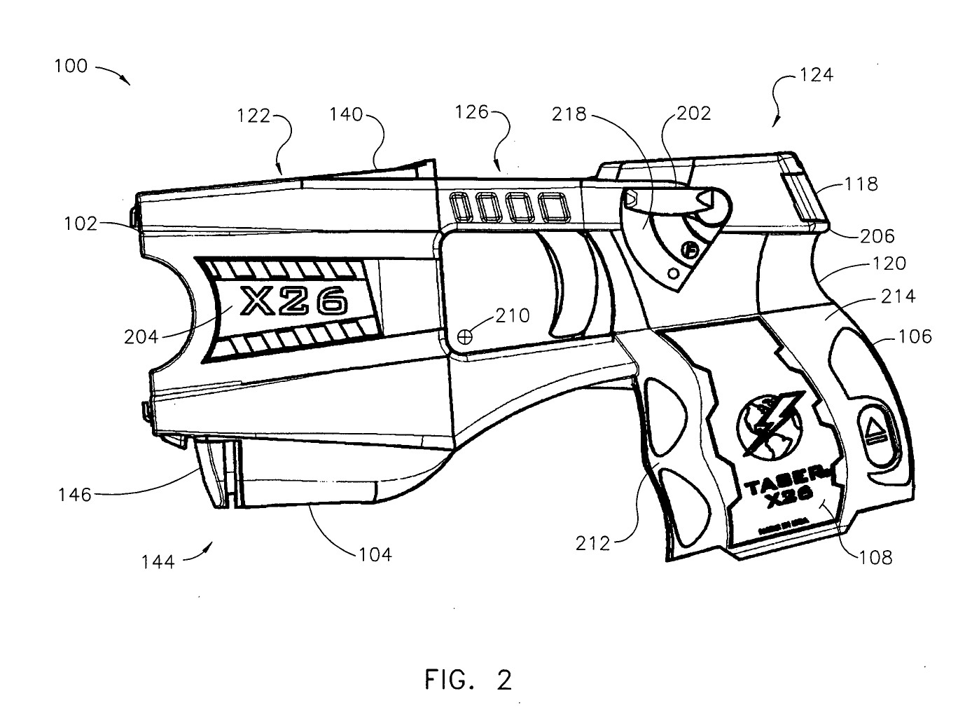

FIGS. 1-4 illustrate an exemplary electric discharge weapon 100 in accordance with an embodiment of the present invention. The weapon 100 may include a body portion 128 (also referred to as a “discharge portion”) adapted for delivering a force (such as, for example, an electric discharge) at a target. The body portion 128 may have opposite front and back ends 102, 120, and front, back and middle regions 122, 124, 126 with the middle region 126 interposed between the front and back regions 122, 124 (see FIG. 2). The weapon 100 may also have a downwardly depending handgrip 106 adapted for gripping by a user's hand. The handgrip 106 may be located towards the back end 120 of the body portion 128.

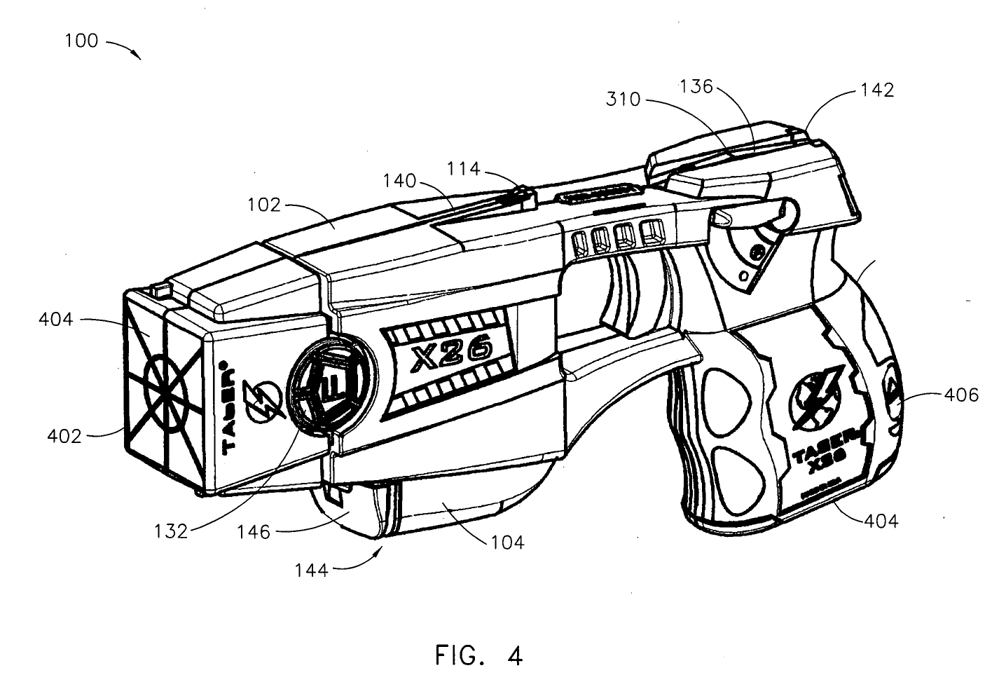

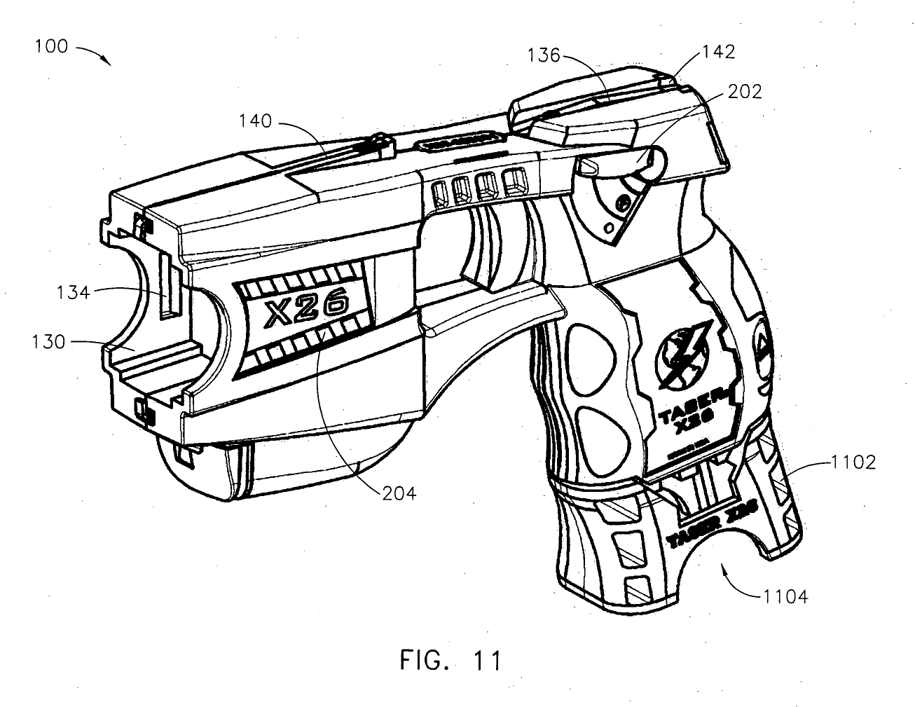

As best shown in FIGS. 1 and 11, the front end 102 of the body portion 128 may have therein a socket 130. The socket 130 is adapted for receiving therein a discharge cartridge 402 (see FIG. 4). In one embodiment, the discharge cartridge 402 may have a latching mechanism 132 adapted for engaging a detent (see FIG. 1) in the socket 130 to releasably hold the discharge cartridge 402 in the socket 130.

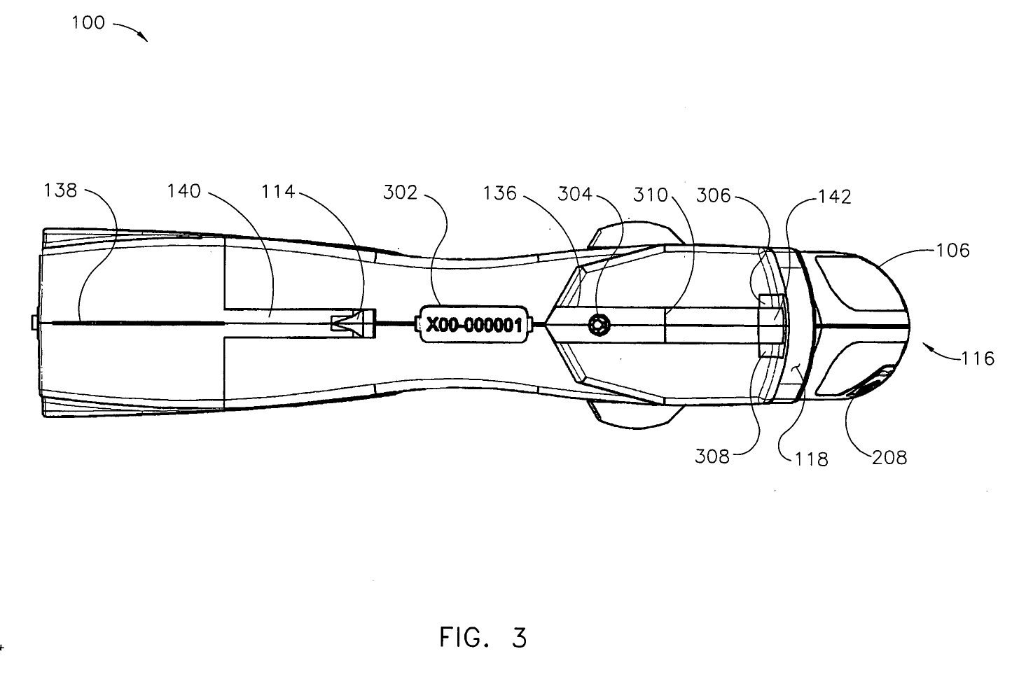

As shown in FIGS. 1-4, the body portion 128 may include a raised rear area 116 upwardly extending from the body portion 128 adjacent the back end 120 of the body portion 128. The raised rear area 116 may include a longitudinal aiming groove 136 in an upper face of the raised rear area 116 that extends in a direction substantially parallel to a longitudinal axis of the body portion extending extends between the front and back ends of the body portion (the longitudinal axis may be parallel to the line 138 formed in the top face of the body portion (see FIG. 3)). As can be seen in FIGS. 1 and 3, a bottom wall of the aiming groove 136 may be sloped so that it forms a peak 310 in a middle area of the aiming groove 136.

The body portion 132 may also have a generally triangular blade-type sight 140 upwardly extending from a top face of the body portion 128. The sight 140 may be spaced apart from both the front end 102 of the body portion 128 and the raised rear area 116. In one embodiment, the sight 140 and the aiming groove 136 may lie along a common axis (e.g., line 138) that extends in a direction substantially parallel to the longitudinal axis of the body portion. As may be seen in FIG. 2, the sight 140 may have a pointed forwards end, a raised rear end and a sloped upper edge that slopes in a downwards direction from the rear end towards the forwards end of the sight 140.

The sight 140 may also include a generally triangular shaped fin 114 for helping aim of the weapon at an intended target. In such an embodiment, the fin 114 may be located on the upper edge of the sight 140 so that it is positioned adjacent the rear end of the sight 140. Also, a front apex (i.e., point) of the fin may lie on the common axis 138 of the sight 140 and aiming groove 136. In one embodiment, the fin may be colored in a color different (and preferably a contrasting color) than a general exterior color of the body portion 128. For example, the fin 114 may be colored yellow, red, orange, white or even a fluorescent or phosphorescent color to enhance its visibility to a user of the weapon 100—especially when the user is aiming the weapon at an intended target by using the sight 140. In such an embodiment, the fin may be constructed from or coated with a fluorescent or phosphorescent colored material such as a fluorescent or phosphorescent colored plastic or other polymer substance or even a colored paint or dye.

Similarly, the raised rear area may also have a colored region 142 that is colored in a color different (and preferably a contrasting color) than a general exterior color of the body portion 128. For example, the colored region 142 may be colored yellow, red, orange, white or even a fluorescent or phosphorescent color to enhance its visibility to a user of the weapon 100—especially when the user is aiming the weapon at an intended target by using the sight 140 and aiming groove 136 (like the fin 114, the colored region 142 may also be constructed from or coated with a fluorescent or phosphorescent colored material such as a fluorescent or phosphorescent colored plastic or other polymer substance). In such an embodiment, the colored region 142 may be located towards the back end 120 and extend along back and side walls of the aiming groove 136 (adjacent the open rear end of the aiming groove 136 ) and adjacent areas of upper and rear faces 306, 308 of the raised rear area 116 (see FIG. 3). Additionally, in one embodiment, the colored region 142 may be the same color as the color of the fin 114.

In use, a user may aim the weapon 100 by looking through the groove 136 in a direction towards an intended target and lining up a location on the target with the sight 140 and the fin 114. In one embodiment, the sight 140, fin 114 and aiming groove 136 may be in alignment with a projectile discharge from a discharge cartridge 402 inserted into the socket 130 so that the line of sight through the sight 140, fin 114 and aiming groove 136 intersects at least one point on the expected trajectory of the projectile from the weapon 100.

With particular reference to FIGS. 2 and 3, the body portion may have a display 118 (e.g., a liquid crystal or LED display) for displaying information (e.g., status information about the weapon generated by circuitry in the weapon 100) to a user. The display 118 may be located on a rear face of the raised rear area 116 adjacent the back end 120 of the body portion 128 and above an upper end region of the handgrip 106. In one embodiment, the display 118 may have a generally rectangular outer perimeter and a slightly convex face (also referred to as a lens) that is flush with the contour of the adjacent areas of the raised rear region 116. In a preferred embodiment (and best illustrated in FIG. 3), the display 118 may be angled (i.e., orientated) at an obtuse angle with respect to the longitudinal axis extending between the front and back ends 102, 120 of the body portion 128 (i.e., generally parallel to line 138) so that display 118 is angled in an upwards direction to permit easier viewing of the display 118 by a user when holding the weapon with the handgrip 106.

The body portion 128 may also have one or more light sources 144 mounted thereto. In one embodiment, the light source(s) 144 may be mounted a bottom face of the body portion 128 so that the one or more light source(s) 144 do not obstruct a line of sight of a user when aiming the weapon 100 at a target. As illustrated in FIGS. 1, 2 and 4, the light source(s) may be disposed in a compartment 104 depending from the bottom face of the body portion 128. In one such embodiment, the compartment 104 may be constructed to be an integral part of the body portion 128. The compartment 104 may have a translucent or transparent window 146 located towards the front end 102 of the body portion 128 for permitting light from the light source(s) 144 to shine out from the compartment 104 in a forwards direction.

In one embodiment, the light source(s) 144 may include a coherent light source (e.g., a laser) for forwardly projecting a beam of coherent light therefrom through the window 146. In such an embodiment, the coherent light source may be aligned with a line of sight formed along an axis through the sight 140, fin 114, and aiming groove 136 so that the line of sight is intersected by the beam of coherent light emitted from the coherent light source. As a further option, the sight 140, fin 114, and aiming groove 136 and coherent light source may be aligned with the expected flight path of a projectile discharged from the discharge cartridge 402 so that line of sight and beam of coherent light intersect the expected flight path as well. This way, the point of intersection of the light of sight and the beam of coherent light may be used to aim the weapon at an intended target so that the projectile from the discharge cartridge may reach the target at that point of intersection.

In one embodiment, the light source(s) 144 may include a generalized light source (either with or without the coherent light source). The generalized light source may comprise one or more light emitting diodes (LEDs) for providing illuminating to a more generalized area in front of the front end of the body portion. In such an embodiment, the LEDs may preferably comprise a type of LED known as a super bright illumination LED.

The light source(s) 144 may also have a light switch for controlling activation of the light source(s) 144. The light switch 144 may have an actuator 304 for actuating the switch. In one embodiment, the actuator 304 may comprises a push-button-type actuator. As shown in FIG. 3, the actuator 304 may be located in the aiming groove 136 to help prevent (or protect against) accidental or unintended actuation of the switch by during use of the weapon. In such an embodiment, the actuator 304 may be located in a bottom wall of the aiming groove 136 and positioned towards a front open end of the aiming groove 136. In addition, the exterior contour of the actuator 304 may lie flush with the contour of bottom wall of the aiming groove 136 so that the actuator 304 does not hinder a user's line of sight through the aiming groove 136 during use of the weapon.

By actuation of the actuator 304 (e.g., depression of a push-button actuator), the light switch may be cycled through a plurality of states to control activation of the light sources 144. Using the previously mentioned exemplary light sources, the light switch may be cycled through the following states through actuation of the actuator 304: a first state in which the light switch activates the coherent light source, a second state in which the light switch activates the generalized light source, a third state in which the light switch activates both the coherent light source and the generalized light source, and a fourth state in which the light switch deactivates all of the light sources.

The weapon 100 may also include a trigger 112 for initiating a process for projecting of a force from body portion 128 in a forwards direction from the front end 102 of the body portion 128 (e.g., discharging a projectile from the discharge cartridge 402). The trigger 112 may be movably mounted (either pivotally or slidably) to the body portion 128 so that the trigger 112 is moveable (i.e., pivotable or slidable) between a first position (also referred to as a resting position) and a second position (also referred to an activating position). In an exemplary embodiment, the first position (which is shown in FIGS. 1, 2, 4, and 11) may be located in front of the second position with the second position being positioned closer to the handgrip 106 than the first position. In one embodiment, the trigger 112 may be biased towards the first position so that it returns to the first position if released from the second position. In use, moving the trigger 112 into the second position may initiates activation of the process for projecting a force from the body portion (e.g., moving the trigger 112 to the second position may initiate discharge and/or electric charge processes in the weapon 100 that lead to the discharging of a projectile towards the target and generation of an electrical charge for applying to the target via the projectiles).

The body portion 128 may also include a finger hole 110 in the middle region 126 of the body portion 128. The finger hole 110 may be located proximal to the handgrip 106 to permit insertion therein of an index finger of a user's hand when gripping the handgrip 106.

Turning to the handgrip 106, fore and aft regions 212, 214 of the handgrip may be constructed from a resiliently compressible material (e.g., a resiliently compressible plastic or rubber material) so that the fore and aft regions 212, 214 may help enhance a user's grip when gripping the handgrip 106 as well as help protect the handgrip 106 from damage when struck by hard objects. The handgrip 106 may also have a pair of side regions each having an exterior face 108, 216 that comprise a metal (or metallic) material for helping to protect the handgrip from damage.

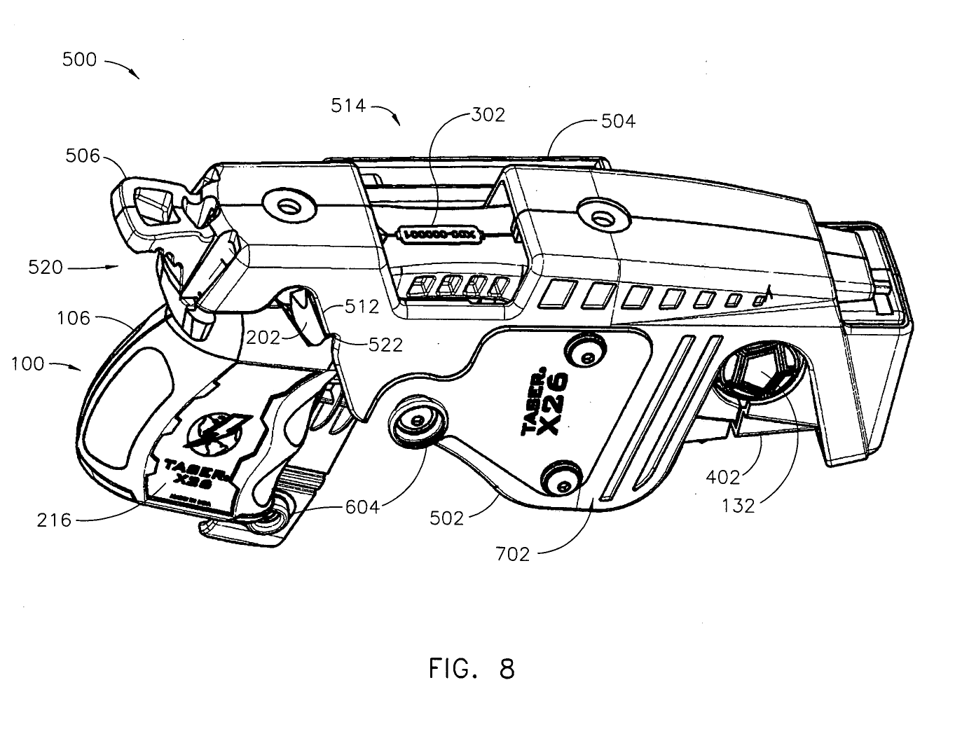

In one embodiment, a plate 302 may be coupled to the body portion 128. As shown in FIGS. 3 and 8, the plate 302 may have indicia displayed thereon, such as, for example, an identifier associated with the weapon 100 (e.g., a serial number of the weapon 100). As shown in FIG. 3, the plate may be positioned on the top face of the body portion 128 and located in the middle region 126 of the body portion 126 for easy and convenient locating and viewing of the indicia on the plate 302.

The body portion 128 may also have a variety of indicia displayed thereon that indicates that the weapon 100 is a non-lethal force weapon. For example, this indicia may take the form of a color or color scheme associated with non-lethal weaponry. As shown in FIGS. 1, 2, 4 and 11, the indicia may be displayed on a pair of labels 204 coupled to either side of the front region 122 of the body portion 128.

A safety switch 202 may be pivotally coupled to the body portion 128. In one embodiment, the safety switch 202 may be located in the back region 124 of the body portion 128 above the handgrip 106 to assist easy pivoting of the safety switch 204 by a user's thumb when the user's hand is gripping the handgrip 106. As a further option, safety switch lies in a depression in a side face of the body portion to help limit the range of movement of the safety switch 202.

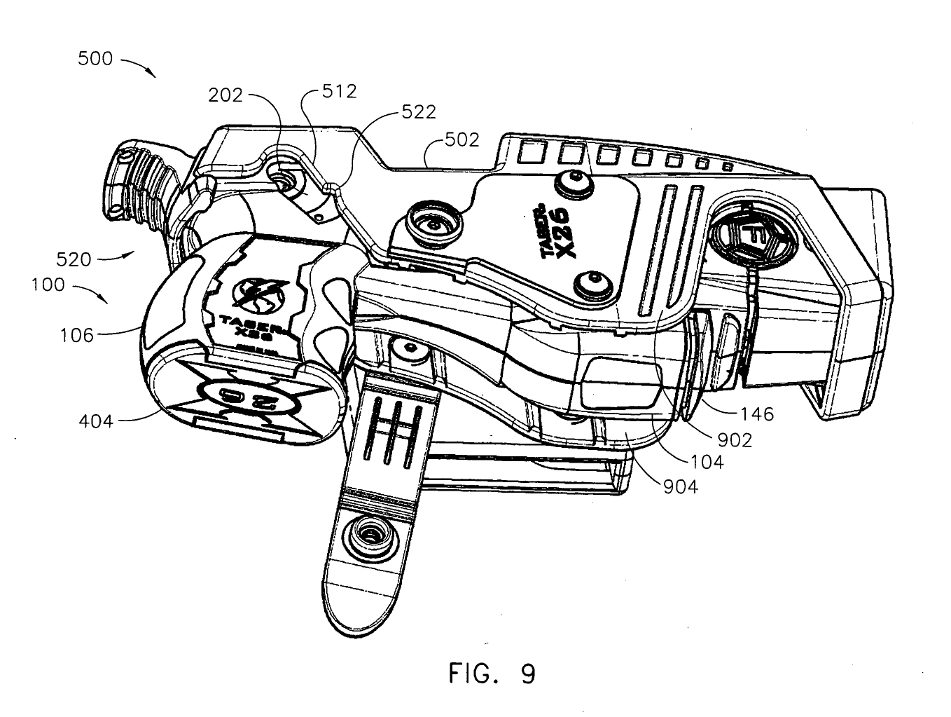

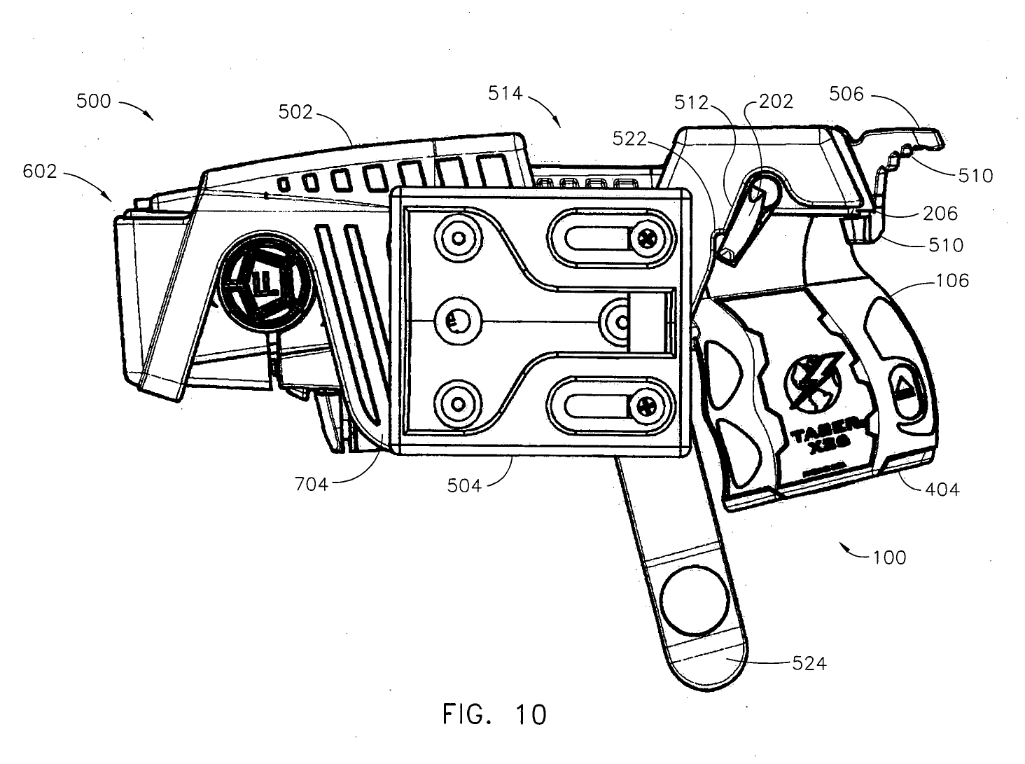

In use, the safety switch 202 may be pivotably positionable between a locked position (an exemplary locked position is shown in FIGS. 9 and 10) and unlocked position (an exemplary unlocked position is shown in FIGS. 1, 2, 4, and 11). The safety switch 202 may be operationally coupled to the trigger 112 so that when the safety switch 202 is in the locked position, the trigger is locked (i.e., held) in the first position and cannot be moved to the second position; and when the safety switch 202 is in the unlocked position, the trigger 112 can be moved between the first and second positions (and thereby permit discharging of the weapon).

With particular reference to FIGS. 9 and 11, the handgrip 106 may have a cavity therein with a bottom opening 404 into the cavity. A power supply 1104, such a battery, may be inserted into the cavity 404. The power supply 1104 may also include circuitry having a memory for storing revision software update. In such an embodiment, when the power supply 1104 is insert into the cavity 404, the circuitry of the power supply 1104 may be coupled to the internal circuitry of the weapon 100 to permit logging of the insertion of battery module into a memory of the circuitry in the weapon 100 and activate the software update. As a further option, a shooting log that records the number of times the weapon 100 is discharged may be maintained by the circuitry in the weapon 100 stored in the memory of the weapon 100. In a further embodiment, the memory of the power supply 1104 may also contain warranty information that may also be downloaded into the memory of the weapon 100 so that the weapon may receive benefits under the warranty. The memory of the weapon 100 may also store a unique identifier associated with the circuitry 100 of the weapon so that unique identifier may be downloaded into the memory of the power supply 1104 so that the power supply may be used elsewhere (e.g., non-initial installations).

The handgrip 106 may also have a locking mechanism for releasably holding the power supply 1104 in a fixed position in the cavity 404. In such an embodiment, the power supply 1104 may also include one or more notches 1102 for engaging a corresponding portion of the locking mechanism to releasably hold the power supply 1104 in the cavity 404. The locking mechanism may also include a movable sliding-type latch 406 to permit selective releasing of the locking mechanism to thereby release the power supply 1104 from the cavity 404. In a preferred embodiment, the latch 406 may be located in the aft region 214 of the handgrip 106 to avoid unintentional sliding of the latch 406 (and thereby release the power supply from the locking mechanism by users that are used to using a similar sliding-type latch that releases a magazine from the handgrip butt of a handgun type firearm).

In one embodiment, the weapon 100 may have a center of gravity 210 located towards a lower corner area inside the finger hole 110 when the discharge cartridge 402 is removed from the socket 130 of the body portion 128 and when the power supply 1104 is inserted into the cavity 404 of the handgrip 106.

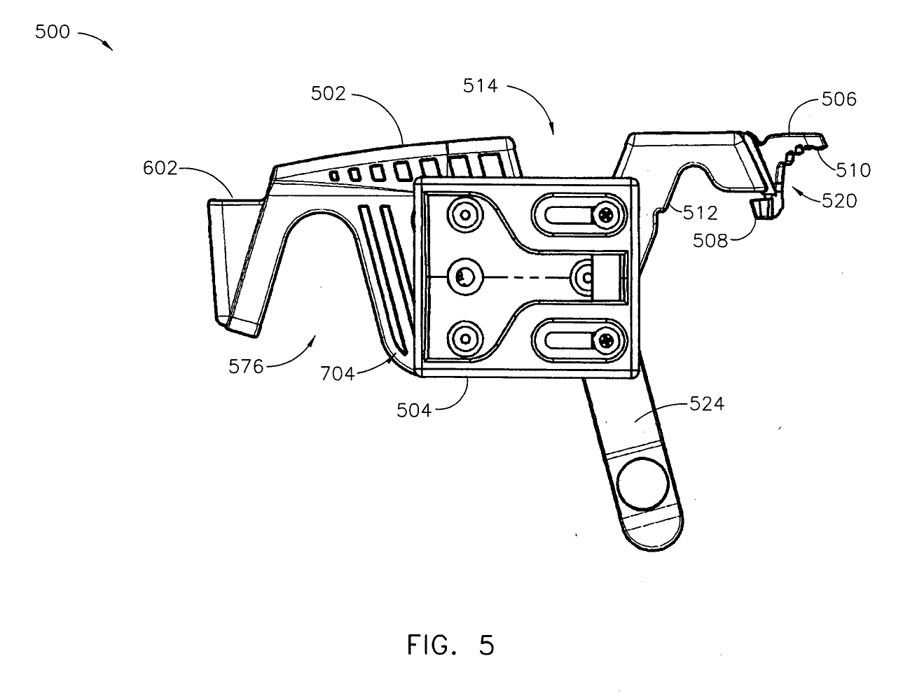

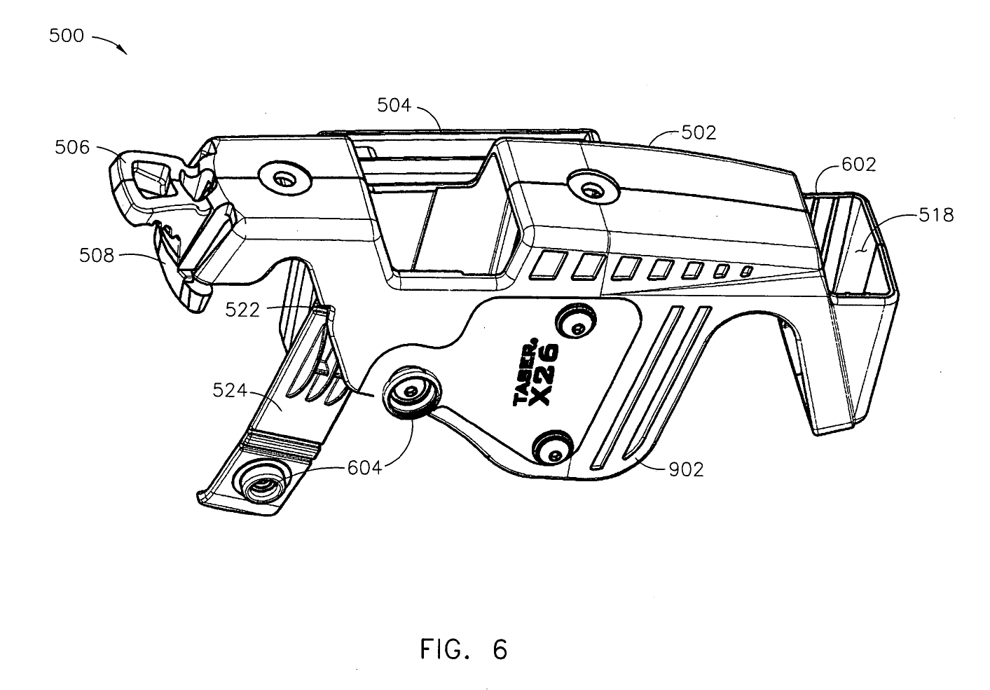

FIGS. 5-10 illustrate an exemplary holster 500 in accordance with an embodiment of the present invention. In use, the holster 500 may be adapted for receiving a weapon. FIGS. 8-10 further depict an exemplary weapon 100 inserted into the holster in accordance with an embodiment of the present invention.

The holster 500 may comprise a spaced apart pair of side walls 702, 704, a top wall 502 and a front wall 518 with the top and front walls 502, 518 connecting the side walls 702, 704 together. A weapon space 706 for receiving a weapon 100 is defined by the top, front and side walls 502, 518, 702, 704. In one embodiment, the top and front walls 502, 518 may be spaced apart to define between them a front opening 602 into the weapon space 706. As shown in FIGS. 8 and 10, in use, the front opening 602 may receive a portion of the discharge cartridge 402 (when inserted into the socket of the body portion of the weapon) when the weapon 100 is inserted into the weapon space 706. Also in use, the front wall 518 may cover at least a portion of the front end cover 408 of the discharge cartridge 402 when the weapon 100 is completely inserted in the weapon space 706. In such an embodiment, the cover 408 of the discharge cartridge 402 may abut an inside face of the front wall 518 when the weapon 100 is in the weapon space 706.

Each of the side walls 702, 704 may have a generally V-shaped side opening 516 into the weapon space 706 for exposing adjacent push button actuators 132 of the latching mechanism of the discharge cartridge 402 when the weapon 100 is inserted into the weapon space 706. Also, each side wall may have a region adapted for covering corresponding sides of the illumination compartment 104 of the weapon 100 when the weapon 100 is inserted into the weapon space 706 (see FIG. 9).

In one embodiment, the top wall 502 may have a generally rectangular middle opening 514 therethrough (see FIG. 5). The middle opening 514 may be located at a position in the top wall 502 so that the indicia on the plate 302 coupled to the body portion 128 of the weapon 100 may be visible through the middle opening 514 when the weapon is inserted into the weapon space 706 (as shown in FIG. 8).

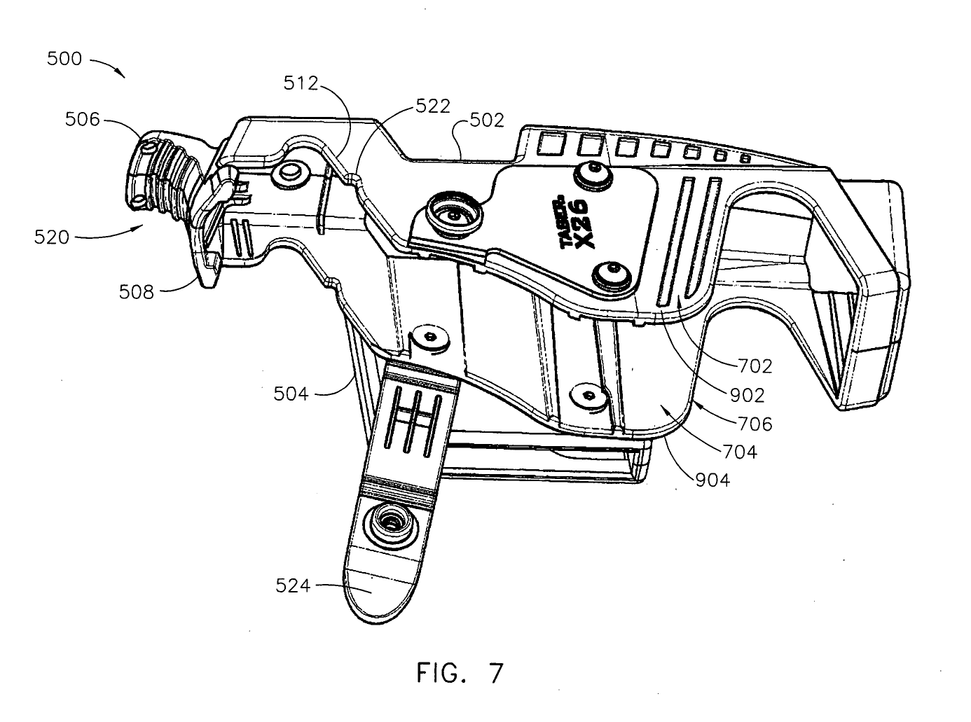

The holster 500 may also include a back wall 520 coupled to a back edge of the top wall 502 to permit resilient deflection of the back wall 520 with respect to the top wall 502. In use, the back wall may cover at least a portion of the display 118 when the weapon 100 is inserted into the weapon space 706 to prevent unintentional scratching of the lens of the display 118 when the weapon is holstered (see FIGS. 8 and 10). As an option, the back wall 520 may further have a thumb grip/lever 506 for permitting a user to deflect the back wall 520 with respect to the top wall with the user's thumb. In one such embodiment, the thumb lever 506 may include a plurality of friction enhancing ridges 510. In use, the ridges 510 may engage a user's thumb to prevent the user's thumb from sliding off of the lever 506 when deflecting the lever 506. The back wall 520 may also having a lip 508 (see FIGS. 5 and 7). As shown in FIGS. 8 and 10, the lip 508 may be adapted for releasably engaging a lower corner of the raised region 116 of the weapon located above the top end of the handgrip 106 when the weapon 100 is inserted into the weapon space 706 to releasably hold the weapon 100 in the weapon space 706 until the back wall 520 is deflected to a position where the lip 508 is disengaged from the lower corner of the raised rear region 116 of the weapon.

In one embodiment, at least one of the side walls (e.g., side wall 702) may having a generally V-shaped edge region 512. In use, the edge region 512 holds the safety switch 202 in the locked position when the weapon 100 is inserted into the weapon space 706. As a further option, a notch 522 may be located in one arm of the edge region 512. The notch is adapted for urging the safety switch 202 from the unlocked position to the locked position as the weapon 100 is inserted into the weapon space 706.

The holster 500 may also include a holding strap 524 coupled to the side walls 702, 704 to hold the weapon 100 in the weapon space. In such an embodiment, at least one end of the holding strap 524 may be detachably coupled to one of the side walls using, for example a snap fastener 604.

The holster 500 may also include a belt loop 504 coupled to one of the side walls (e.g., side wall 704). The belt loop is adapted for extending a belt therethrough to permit attachment of the holster to body of a user.

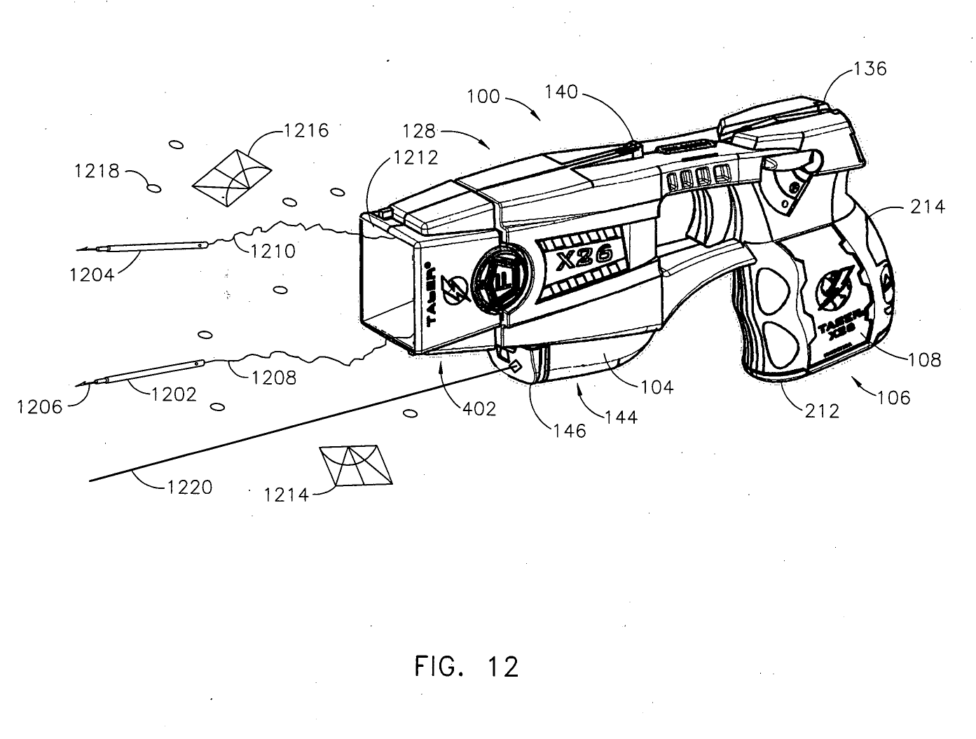

FIG. 12 illustrates the discharge of exemplary projectiles (i.e. probes 1202, 1204) from an illustrative discharge cartridge 402 of an embodiment of an electric discharge weapon 100. Upon actuation of the trigger 112 from the first position to the second position, control circuitry in the weapon 100 is activated to cause the discharge of a plurality of projectiles 1202, 1204 in an forwards direction from the discharge cartridge 402.

The discharge cartridge 420 may include a propulsion system (or at least a portion thereof) for projecting the projectiles 1202, 1204 contained in the discharge cartridge 402 a distance away from the front of the discharge cartridge 402. The propulsion system may be activated to propel the projectiles by a discharge controller portion of the circuitry contained in the weapon 100 upon actuation of the trigger 112. An exemplary propulsion system may be implemented using techniques described in U.S. Pat. No. 5,078,117 to Cover entitled “Projectile Propellant Apparatus and Method” which is incorporated herein by reference.

As shown in the exemplary embodiment in FIG. 12, the plurality of projectiles may comprise a pair of probes 1202, 1204. With reference to probe 1202, each probe may have a pointed tip 1206 for insertion into a target (e.g., the skin or clothing of a human target). As an option, the tip 1206 may be barbed to help hold the tip to the target after insertion. Each probe 1202, 1204 may be electrically conductive and may be coupled to the circuitry of the weapon 100 by a flexible conductive filament 1208, 1210. An electric charge generator coupled to and controlled by the circuitry of the weapon 100 may provide an electrical charge to the probes 1202, 1204 via the filaments 1208, 1210 so that the electrical charge is applied to the target upon either close proximity to or contact with the probes 1202, 1204 to immobilize the target with the electrical charge. In another embodiment, the probes may themselves contain a means for generating the electric charge that is applied to the target. In one embodiment, the probes 1202, 1204 may be positioned in a vertical alignment in the discharge cartridge 402 so that one probe is located above the other probe (i.e. so that there is a top probe (e.g., probe 1204) and a bottom probe (e.g., probe 1202)) when the weapon 100 is positioned in a typical upright position (as shown in FIG. 12).

Prior to discharge, the probes 1202, 1204 and filaments 1208, 1210 may be contained in a compartment or cavity 1212 inside the discharge cartridge 402 that is covered by a removable cover. As shown in the exemplary embodiment in FIG. 12, the cover may comprise a pair of blast doors 1214, 1216 which are blown away from the compartment 1212 by the discharge of the probes 1202, 1204 out of the discharge cartridge 402.

As an option, the compartment 1212 may also contain a plurality of tracking tags 1218 having identifying information or indicia (e.g. a unique serial number) that identifies the associated discharge cartridge 402. In use, as a result of the probes 1202, 1204 being discharged from the discharge cartridge 402, the tracking tags 1218 are also expelled from the discharge cartridge 402 to permit subsequent identification of the expended discharge cartridge 402 and general location where the discharge cartridge 402 was discharged based on the identifying information contained on the tracking tags 1218 and the location where the expelled tracking tags 1218 land.

In an embodiment where the light source 144 comprises a coherent light source, the beam of coherent light 1220 emitted by the light source 144 may be used to aim the weapon 100 at the intended target by illuminating the intended target. In such an embodiment, the light source 144 may even be aligned in a path generally parallel to the expected flight path of at least one of the probes (such as e.g., the top probe 1204) so that the beam of light 1220 emitted from the light source may be used to approximate an intended target for the associated probe. In addition, the beam 1220 may be in alignment with the line of sight defined by the sight 140 and aiming groove 136 as previously discussed.

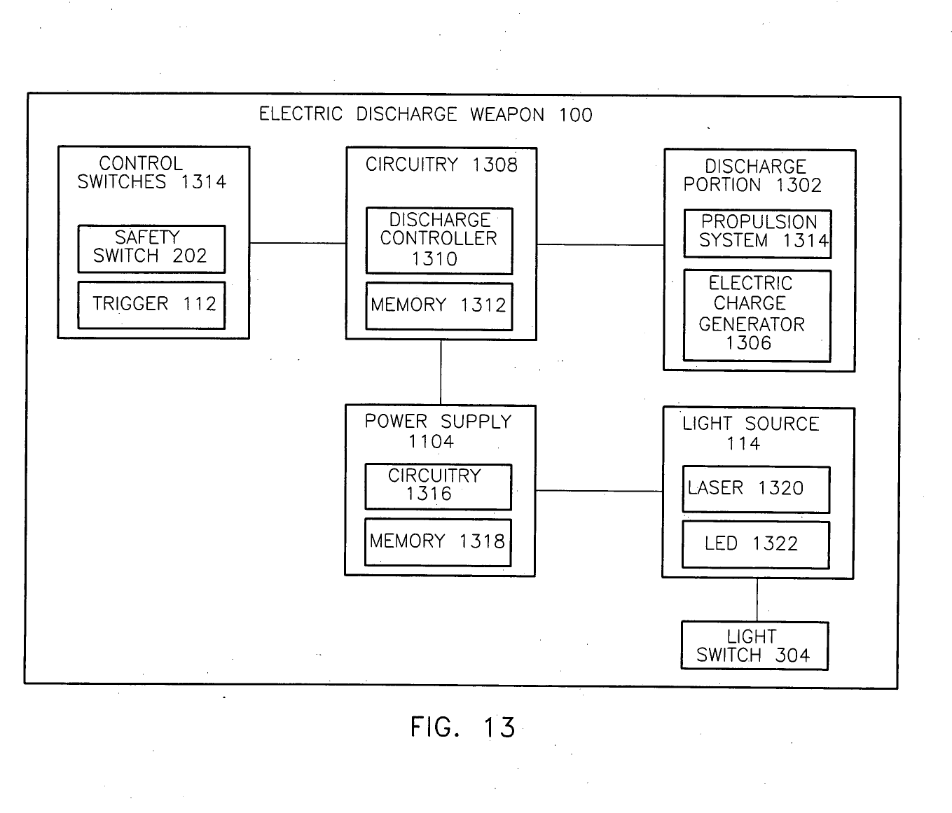

FIG. 13 is a schematic block diagram of an exemplary embodiment of an electric discharge weapon 100. The weapon 100 may include a discharge portion 1302 for discharging a force such as, for example an electric discharge. The discharge portion 1302 may include a propulsion system 1304 for propelling one or more projectiles from the discharge portion 1302. Aspects of the discharge portion may be located in the body portion 128 and/or the discharge cartridge 402. The discharge portion 1302 may also include an electric charge generator 1306 for generating an electric charge for applying to a target (e.g., via probes 1202, 1204 and filaments 1208, 1210 which may be coupled to the electric charge generator 1306).

The weapon 100 may include control circuitry 1308 for controlling and monitoring various elements and aspects of the weapon 100. For example, the control circuitry may include an discharge controller 1310 for controlling the discharge portion (including control of the propulsion system 1304 and the electric charge generator 1306). The control circuitry may also include a memory 1312 for storing data and other information therein.

A plurality of control switches 1314 may be coupled to the control circuitry 1308 for controlling activation of various elements and aspects of the control circuitry 1308 and the discharge portion 1302. For example, the control switches 1314 may include the trigger 112 and safety switch 202 which may be used to initiate the discharge of projectiles and generation of an electric charge by the discharge portion 1302.

The power supply 1104 may be coupled to the circuitry 1308 to provide power to the various elements of the weapon including, for example, the circuitry 1308 and the discharge portion 1302. In one embodiment, the power supply 1104 may include circuitry 1316 and a memory 1318 which may be coupled to the control circuitry 1308 of the weapon 100 when the power supply is inserted into the weapon 100. The light source(s) 114 (including, for example, a coherent light source 1320 and an LED light source 1322) may also be coupled to the power supply for providing power to the light source(s) 114. The light switch 304 may also be coupled to the light source(s) 114 for controlling the light source(s) 114.

In addition to the description set forth above, various aspects of these elements of the electric discharge weapon 100 may be implemented with the help of the techniques described in U.S. Pat. No. 5,654,867 to Murray, U.S. Pat. No. 5,698,815 to Ragner, U.S. Pat. No. 4,253,132 to Cover and U.S. Published application Ser. No. 2004/0045207 published Mar. 11, 2004 (inventor: James F. McNulty, Jr.) each of which is incorporated by reference herein.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

1. A weapon, comprising:
a body portion adapted for discharging a force towards a target;
a handgrip coupled to the body portion;
a trigger adapted for initiating the discharge of the force; and
a display coupled to the body portion.

2. The weapon of claim 1, wherein the body portion has a longitudinal aiming groove in an top face of the body portion.

3. The weapon of claim 2, further comprising a sight coupled to the top face of the body portion, the sight and the aiming groove lying along a common axis.

4. The weapon of claim 3, further comprising a fin coupled to the sight, the fin having an apex lying along the common axis.

5. The weapon of claim 4, wherein the body portion has a colored region extending into a back end area of the aiming groove, wherein the colored region and the fin are colored in a common color.

6. The weapon of claim 5, wherein the common color comprises a phosphorescent color.

7. The weapon of claim 2, wherein the display is positioned beneath a back end of the aiming groove.

8. The weapon of claim 1, wherein the display is orientated at an obtuse angle to a longitudinal axis of the body portion.

9. The weapon of claim 1, further comprising a light source coupled to a lower face of the body portion and positioned towards a front end of the body portion.

10. The weapon of claim 9, further comprising a switch for controlling activation of the light source, wherein the switch is located in an aiming groove in the body portion.

11. The weapon of claim 1, wherein the trigger is located in a finger hole in the body portion, and wherein a center of gravity of the weapon is located in the finger hole.

12. The weapon of claim 11, wherein the weapon has a center of gravity located towards a bottom forwards area inside the finger hole.

13. The weapon of claim 1, wherein the handgrip has a fore and aft regions comprising a resiliently compressible material.

14. The weapon of claim 13, wherein the handgrip has a pair of side regions each having an exterior face comprising a metallic material.

15. The weapon of claim 1, further comprising a plate coupled to the body portion, the plate displaying thereon indicia comprising an identifier associated with the weapon.

16. The weapon of claim 15, wherein the plate is located on a top face of the body portion in a middle region of the body portion.

17. The weapon of claim 1, wherein the body portion has indicia displayed thereon for indicating that the weapon is a non-lethal force weapon.

18. The weapon of claim 17, wherein the indicia is a color associated with non-lethal weaponry

19. The weapon of claim 1, wherein the weapon comprises an electric discharge weapon.

20. The weapon of claim 1, wherein the handgrip has a cavity therein for receiving a power supply and a locking mechanism for releasably holding the power supply in the cavity.

21. The weapon of claim 20, wherein the power supply comprises a battery.

22. A weapon system, comprising:
a weapon comprising a body portion adapted for discharging a force towards a target, a handgrip coupled to the body portion, a trigger adapted for initiating the discharge of the force, and a display coupled to the body portion; and
a holster receiving the weapon, the holster having a back portion that covers the display of the weapon when the weapon is inserted into the holster.

23. The weapon system of claim 22, wherein the weapon has a safety switch coupled to the body portion, the safety switch being movable between a locked position and an unlocked position.

24. The weapon system of claim 23, wherein the holster has a generally V-shaped edge with a notch therein, the notch being adapted for urging the safety switch from the unlocked position to the locked position as the weapon is inserted into the holster, the V-shaped edge of the holster holding the safety switch in the locked position when the weapon is in the holster.

25. The weapon system of claim 22, wherein the back portion of the holster is resiliently deflectable and has a thumb grip extending therefrom for assisting deflection of the back portion by a user.

26. The weapon system of claim 22, wherein the weapon has a plate coupled to the body portion, the plate displaying thereon indicia comprising an identifier associated with the weapon.

27. The weapon system of claim 26, wherein the holster has a hole therein positioned such that the plate is visible through the hole when the weapon is in the holster.

28. The weapon system of claim 22, wherein the weapon has a light source coupled to the body portion.

29. The weapon system of claim 22, wherein the holster has a holding strap releasably holding the weapon in the holster.

31. A method, comprising:
providing a weapon comprising a body portion adapted for discharging a force towards a target, a handgrip coupled to the body portion, a trigger adapted for initiating the discharge of the force, and a display coupled to the body portion; and
inserting the weapon in a holster, the holster having a back portion that covers the display of the weapon when the weapon is inserted into the holster.

32. The method of claim 31, wherein the weapon has a safety switch movable between a locked position and an unlocked position, wherein the holster has a side edge adapted for engaging the safety switch to move the safety switch from the unlocked position to the locked position as the weapon is inserted into the holster.

33. A weapon system, comprising:
a weapon; and
a holster receiving the weapon;
wherein, the weapon comprises:
a body portion adapted for discharging an electronic discharge projectile towards a target, the body portion having a longitudinal aiming groove in an top face of the body portion,
a sight coupled to the top face of the body portion, the sight and the aiming groove lying along a common axis;
a fin coupled to the sight, the fin having an apex lying along the common axis;
a colored region on the body portion that extends into a back end area of the aiming groove, the colored region and the fin being colored in a common phosphorescent color;
a handgrip coupled to the body portion, the handgrip having a cavity receiving a power supply therein and a locking mechanism for releasably holding the power supply in the cavity;
a trigger adapted for initiating the discharge of the force; and
a display coupled to the body portion, the display being positioned beneath a back end of the aiming groove orientated at an obtuse angle to a longitudinal axis of the body portion;
a light source coupled to a lower face of the body portion and positioned towards a front end of the body portion;
a switch for controlling activation of the light source, the switch being located in the aiming groove;
a plate coupled to the body portion, the plate displaying thereon indicia comprising an identifier associated with the weapon; and
a safety switch coupled to the body portion, the safety switch being movable between a locked position and an unlocked position;
wherein, the holster comprises:
a back portion that covers the display of the weapon when the weapon is inserted into the holster, the back portion of the holster being resiliently deflectable and having a thumb grip extending therefrom for assisting deflection of the back portion by a user;
a generally V-shaped edge with a notch therein, the notch being adapted for urging the safety switch from the unlocked position to the locked position as the weapon is inserted into the holster, the V-shaped edge of the holster holding the safety switch in the locked position when the weapon is in the holster;
a front portion having a hole therein, the hole positioned so that the plate of the weapon is visible through the hole when the weapon is in the holster; and
a holding strap releasably holding the weapon in the holster.
